(19) United States
(12) Patent Application Publication
(10) Pub. No.: US 2002/0023524 A1
(43) Pub. Date: Feb. 28, 2002

(54) Dual headed pliers with pommeled handles

(76) Inventors: Joseph T. Lowe, Brea, CA (US); Richard G. Lowe, Columbia, MO (US)

Correspondence Address: Jack C. Munro, Agent of Record, 28720 Roadside Drive, Suite 225, Agoura Hills, CA, 91301, US

(21) Appl. No.: 09/871,985

(22) Filed: Jun. 4, 2001

Related U.S. Application Data
(60) Provisional application No. 60/229,147, filed on Aug. 31, 2000.

(51) Int. Cl. B25B 7/00

(52) U.S. Cl. 81/427.5

(57) ABSTRACT

A pliers which has a pair of heads with these heads being reversible so that one head is in a usage position the other head is in a stowage position located between a pair of handles. Each handle of the pair of handles is pivotable about one hundred sixty degrees with the handles to be located in juxtaposition in both the usage position and the stowage position. Each handle including a convex surface and a concave surface and also each handle including a pommel. Each of the convex surfaces and each of the concave surfaces and each of the pommels function to ergonomically assist in grasping of the handles.

### BACKGROUND OF THE INVENTION

1. Field of the Invention

This invention relates generally to tools and more particularly to a pliers type of tool which embodies a pair of different heads within the same tool.

2. Description of the Related Art

Hand tools, of different types, have long been known. A common form of a hand tool is what is known as a pliers. A pliers has a head which is defined by a pair of jaws which can be manipulated by a pair of handles into a pincher-like action on an exterior structure. There are different types of plier heads. There is what is deemed a sharp nose or needle nose type of pliers head. There is also what is referred to as a snub nose type of pliers head. Tradesmen and homeowners frequently carry both types of pliers on their person or within their toolbox. If both heads could somehow be incorporated within a single tool, then the tradesman or homeowner would only be required to carry a single tool rather than two different tools.

In the past, it has been known to form a combination type of tool in the form of a pliers wherein two different types of heads of pliers are incorporated within a single tool. Reference is to be had to prior U.S. Pat. No. 5,245,721 which shows such a combination tool. However, the combination tool of the prior art has certain deficiencies. One of the deficiencies is that the handles are not constructed to ergonomically fit into the user's hand. The combination tool of the mentioned prior art patent utilizes bulbous shaped handles. When a human grasps a pair of pliers, the bulbous shaped handle will fit nicely within the palm area of the hand but the fingers don't connect well with a bulbous shaped handle. It would be desirable to have the fingers go into a cavity rather than an outwardly rounded handle. Also, it would be desirable that regardless which position the handles are in, and depending upon which head is being used, that the fingers are located within a handle concavity.

Additionally, the handles of the combination tool of the prior art previously mentioned does not include any kind of protuberance or pommel which can be used by the user as a “feel” device to inform the user that he or she has correctly grasped the tool. It is to be noted that in some instances, the use of the tool is accomplished in a poorly lighted or unlighted environment. Therefore, the use of such a “feel” device would be desirable. Additionally, during use of a conventional pliers or a combination type pliers of the prior art reference, there is a natural tendency for the user's hands to slide upward on the handles which results in the hand not being placed in the most desirable location in order to apply the maximum amount of torque. It would be desirable to include some type of structure in conjunction with the handles that would tend to prevent the user's hand from sliding on the handles.

### SUMMARY OF THE INVENTION

The basic embodiment of the present invention comprises a pliers which has a first pliers head and a second pliers head located opposite the first pliers head. A first handle and a second handle are connected at a pivot joint between the first pliers head and the second pliers head. The first handle has a convexly curved surface with the second handle also having a convexly curved surface. Both the first handle and second handle are movable within a plane, and each convexly curved surface is located transverse to that plane. One of the convexly curved surfaces forms an interior surface of the handle of the pliers when the first pliers head is located in the usage position and the other convexly curved surface forms an interior surface of the handles when the second pliers head is in the usage position. The first handle has a concave surface located opposite the convex surface. The second handle has a concave surface located opposite the convex surface of this second handle.

In a further embodiment of this invention, is where the basic embodiment has been modified so that the stowage position is located between the handles.

In a still further embodiment of this invention, is where the basic embodiment has been modified to include a first pommel found on the first handle with the first pommel being located on the surface of the handle which is opposite the first convexly curved surface on that handle with this pommel to function as a positioning device to assist in determining proper positioning of the pliers within a user's hand.

In a yet still further embodiment of this invention, is where the basic embodiment has been modified where the second handle includes a second pommel with the second handle being located on a surface of the second handle which is opposite the convexly curved surface. Again, the second pommel is to assist in determining proper positioning of the pliers within a user's hand.

In a still further embodiment of this invention, the basic embodiment is modified to where the first pommel and the second pommel are spaced approximately two inches from the pivot axis of the connecting joint with the free ends of the handles being spaced approximately five and one-half inches from the pivot axis of the connecting joint.

A modified embodiment of the present invention is where there is utilized a pliers which has a pair of heads with these heads being reversible between a usage position and a stowage position. The pliers includes a pair of handles each of which is pivotable relative to the heads with the outer limits of this movement determining the usage position and the stowage position. The handles are to be placed located in juxtaposition in both the usage position and the stowage position. Each handle includes a convex surface and a concave surface with these surfaces functioning to ergonomically assist in grasping of the handles.

In yet a still further embodiment of this invention, the modified embodiment is defined to include a pommel on each handle with each pommel to further assist ergonomically grasping of the handles.

In yet a further embodiment of this invention, the modified embodiment is defined to state that each handle is pivotable about one hundred sixty degrees from the outer limit of movement of the handles.

In yet a further embodiment of this invention, the modified embodiment is defined to state that each pommel is located directly against a concave surface of its respective handle.

A further modified embodiment of the present invention is whre there is utilized a pair of pliers which has a pair of heads with these heads being reversible between a usage position and a stowage position. The pliers includes a pair of handles each of which is pivotable relative to the heads with the outer limits of this movement determining the usage position and the stowage position. The handles are to be placed in juxtaposition in both the usage position and the stowage position. Each handle has a pommel with each pommel to ergonomically assist in grasping of the handles.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a top plan view of the pliers constructed in accordance with this invention showing the snub nose pliers head being located in the usage position and the needle nose pliers head located in the stowage position;

FIG. 2 is a right side elevational view of the pliers of FIG. 1;

FIG. 3 is a view similar to FIG. 1 but showing the user's hand being placed in conjunction with the pliers; and

FIG. 4 is a view similar to FIG. 3 but with the needle nose pliers head being located in the usage position and the user's hand mounted in conjunction with the handles.

### DETAILED DESCRIPTION OF THE INVENTION

Referring particularly to the drawings, there is shown a pliers 10 of this invention which has a snub nose pliers head 12 and a needle nose pliers head 14. The snub nose pliers head 12 and the needle nose pliers head 14 are connected together at a connecting joint 16. Basically, the snub nose piers head 12 is located opposite the needle nose pliers head 14. Jaw element 18 of the snub nose pliers head 12 is integrally connected to jaw element 20 of the needle nose pliers head 14. The jaw element 22 of the snub nose pliers head 12 is integrally connected to jaw element 24 of the needle nose pliers head 14.

The connecting joint 16 includes a pair of secured together large headed pins 26 and 28. Extending longitudinally through the center of the pins 26 and 28 is a pivot axis 30. Included within the connecting joint 16 is a spring arrangement, which is not shown, whose purpose is to exert a continuous bias between the jaw elements 18, 20, 22 and 24 so as to be the normal tendency to locate jaw elements 18 and 22 in a totally open position and also the jaw elements 20 and 24 in a totally open position.

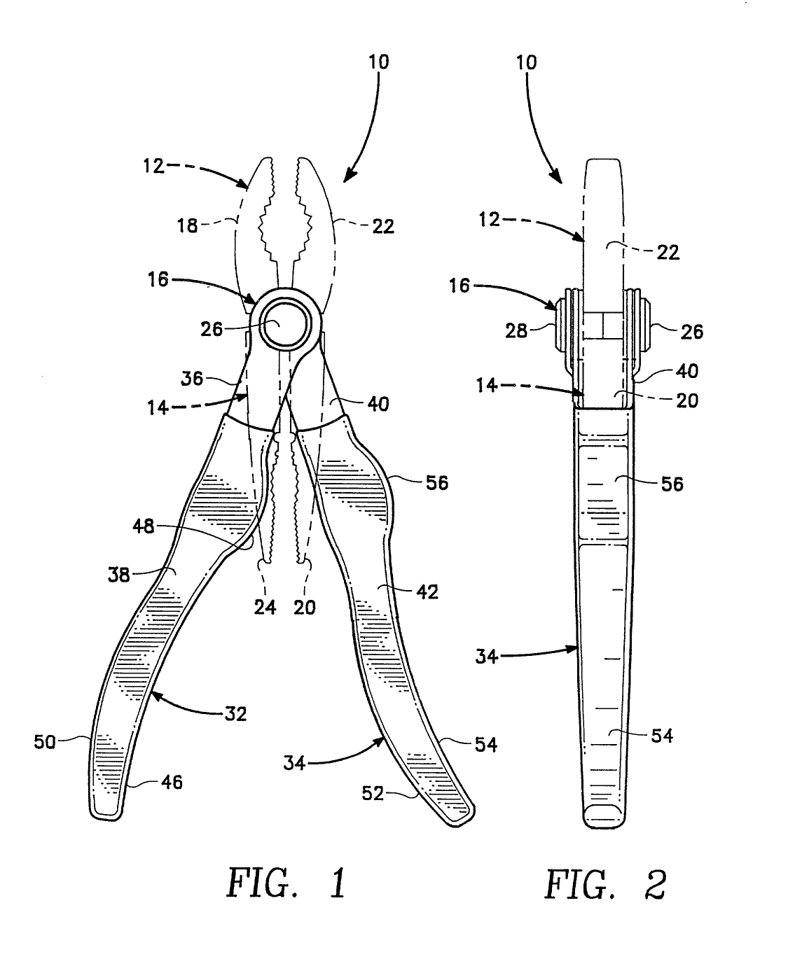

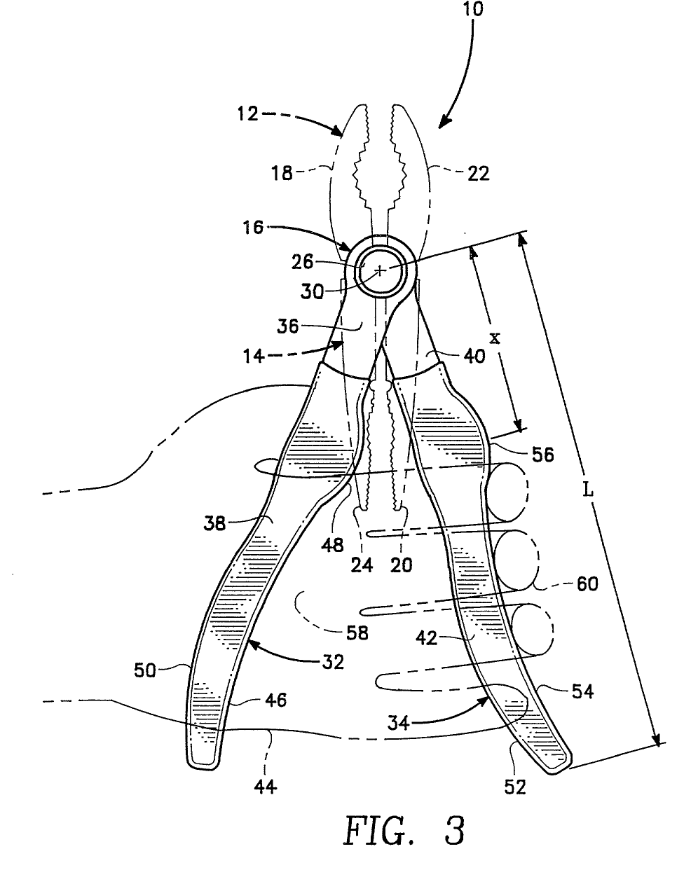

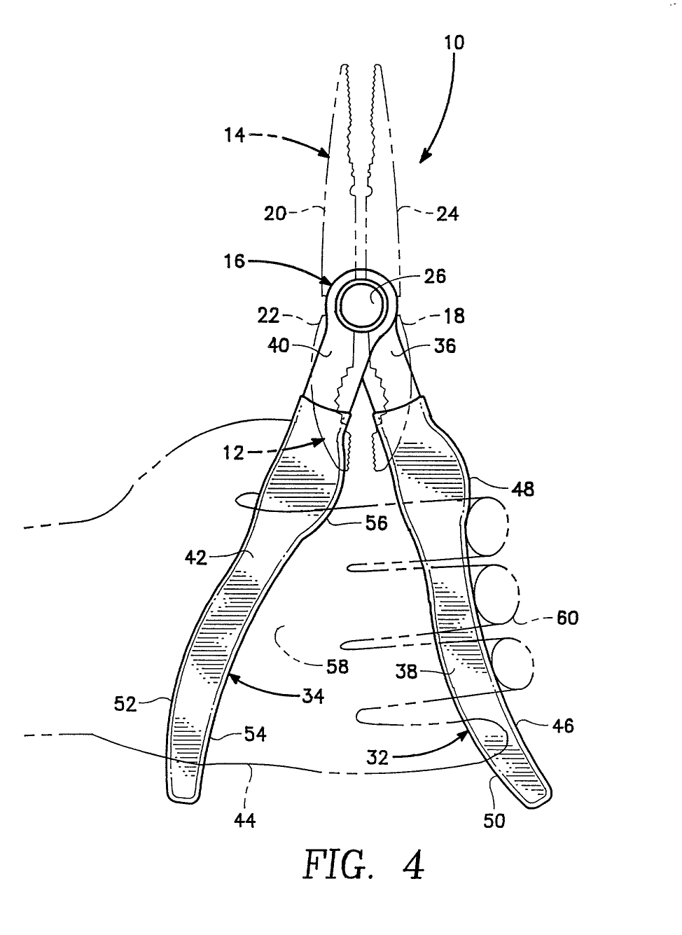

In reference to the drawings, the jaw elements 18, 20, 22 and 24 are not shown in the totally open position as such are held in a partially open position by a first handle 32 and a second handle 34. Either the snub nose pliers head 12 or the needle nose pliers head 14 is located between the handles 32 and 34. In FIGS. 1 and 3, the needle nose pliers head 14 is shown located between the handles 32 and 34, while in FIG. 4, the snub nose pliers head 12 is shown located between the handles 32 and 34.

The outer end of each handle 32 and 34 is bifurcated which defines a pair of legs, and between each of the legs are located a pair of holes which are in alignment. The bifurcated legs of handle 32 are located about the bifurcated legs of handle 34 and then positioned in conjunction with the connecting joint with the pins 26 and 28 extending through the aligned holes and the connecting joints 16. The pins 26 and 28 are then secured together forming a pivot joint that will permit the handles 32 and 34 to be pivoted from the position shown in FIGS. 1 and 3, each about one hundred sixty degrees, which will place the handles 32 and 34 in the position shown in FIG. 4. However, it is to be understood that FIG. 4 has been flopped one hundred eighty degrees so that the needle nose pliers head 14 extends in an upward direction rather than a downward direction.

The first handle 32 includes a metal body 36 which is covered with a rubber or plastic cover 38. In a similar manner, the second handle 34 includes a metal elongated body 40 which is covered by a rubber or plastic covering 42. The covers 38 and 42 are for the purpose of providing a soft, resilient material to be in contact with the user's hand 44.

The first handle 32 has an inner surface 46, which is shown in FIGS. 1 and 3. This inner surface 46 is concave. At the upper end of the concave inner surface 46 is a protuberance that is defined as a pommel 48. The exterior surface 50 of the first handle 32, which is shown as being an exterior surface in FIGS. 1 and 3, is shown to be convex. It is to be understood that the surfaces 46 and 50, though curved in one plane, and basically flat in another plane and are essentially perpendicular to the plane of the paper in the drawings of FIGS. 1 and 3.

The second handle 34 has an inner surface 52, in FIGS. 1 and 3, which is convex. The second handle 34 also has an exterior surface 54 which is concave, which is again shown in FIGS. 1 and 3. This exterior surface 54 connects with a protuberance known as pommel 56. It is to be noted that the distance from the pivot axis 30 to the center of the pommel 56 or the center of the pommel 48 is a distance X, as is shown in FIG. 3. The distance from the pivot axis 30 to the free outer end of either handle 32 or 34 is defined as distance L. Typically, the distance X will be around two to two and one-quarter inches with the distance L being approximately five and one-half inches. However, it is to be understood that these distance measurements could increase and decrease without departing from the scope of this invention. The only reason that the distance measurements are even mentioned is to give a general indication about where the pommels 48 and 56 are to be located.

When a user grasps the handles 32 and 34 with the pliers 10 in the position shown in FIGS. 1 and 3, the user's palm area 58 rides against the exterior surface 50 and the user's fingers 60 are located within the concave exterior surface 54. The fact that the exterior surface 50 is convex provides for a comfortable positioning and application of torque by the user's hand 44. The fact that the exterior surface 54 is concave forms a nice nesting area for the fingers 60. Also, the pommel 48 functions as a guide to indicate to the user the proper location for the fingers 60. Also, the pommel 48 tends to prevent the user's hand from “sliding up” toward the connecting joint 16. The arrangement between the pommel 48, the concave surface 46 and the convex surface 52 functions to ergonomically mount the user's hand when utilizing of the snub nose pliers head 12.

When the handles 32 and 34 are pivoted one hundred sixty degrees, the snub nose pliers head 12 is located between the handles 32 and 34 and in a stowage position with the needle nose pliers head 14 now being exposed for usage. In this particular position, the inner surface 52 now becomes an exterior surface which is to connect with the user's palm area 58. The user's fingers 60 now connect with the inner surface 46 which actually becomes an exterior surface with the fingers 60 nesting within the concave configuration of the inner surface 46. The pommel 56 functions as a positioning device for the user's hand 44 with the pommel 56 concave inner surface 46 and the convex inner surface 52 functioning to ergonomically adapt to the user's hand to facilitate the application of torque by using of the needle nose pliers head 14.

The present invention may be embodied in other specific forms without departing from the essential attributes thereof. Reference should be made to the appending claims rather than the foregoing specification as indicating the scope of the invention.

What is claimed is:

1. A pliers comprising:
a first pliers head, said first pliers head being located within either a usage position or a stowage position;
a second pliers head located opposite said first pliers head, said second pliers head being connected to said first pliers head at a connecting joint, said second pliers head being locatable in either said usage position or said stowage position, with said first pliers head in said usage position said second pliers head is in said stowage position, with said second pliers head in said usage position said first pliers head is in said stowage position;
a first handle being pivotally connected to said connecting joint, a second handle being pivotally connected to said connecting joint, said first handle and said second handle being movable within a plane;
said first handle having a first convexly curved surface which is located transverse to said plane, said first convexly curved surface forming an exterior surface when said first pliers head is in said usage position, said first convexly curved surface forming an interior surface when said first pliers head is in said stowage position;
said second handle having a second convexly curved surface which is located transverse to said plane, said second convexly curved surface forming an exterior surface when said second pliers head is in said usage position, said second convexly curved surface forming an interior surface when said second pliers head is in said stowage position;
the pliers having a pair of heads defined as a first head and a second head, said heads being reversible between a usage position and a stowage position, said pliers comprising:
a pair of handles each of which is pivotable from a first position to a second position with said handles in said first position said first head is in said usage position and said second head is in said stowage position, with said handles in said second position said first head is in said stowage position and said second head is in said usage position, said handles to be located in juxtaposition in both said usage position and said stowage position; and
each said handle including a convex surface and a concave surface, whereby said convex surfaces and said concave surfaces functions to ergonomically assist in grasping of said handles.

2. The pliers as defined in claim 1 wherein:
said stowage position is located between said first handle and said second handle.

3. The pliers as defined in claim 1 wherein:
said first handle having a first free end, a first pommel mounted on said first handle, said first pommel being located on a surface of a first handle which is opposite said first convexly curved surface, said first pommel being located directly adjacent said connecting joint and spaced an extended distance from said first free end, said first pommel to function as a positioning device to abut against an index finger of a user when said second pliers head is in said usage position, said first pommel to assist in determining proper position of said pliers within a user's hand.

4. The pliers as defined in claim 3 wherein:
said second handle having a second free end, a second pommel formed on said second handle, said second pommel being located on a surface of said second handle which is opposite said second convexly curved surface, said second pommel being directly adjacent said connecting joint and spaced an extended distance from said second free end, said second pommel to function as a positioning device to abut against an index finger of a user when said first pliers head is in said usage position, said second pommel to assist in determining proper positioning of the pliers within a user's hand.

5. The pliers as defined in claim 4 wherein:
said connecting joint forming a pivot axis, said first pommel and said second pommel being spaced approximately two inches from said pivot axis, said first free end and said second free end being spaced approximately five and one-half inches from said pivot axis.

6. The pliers having a pair of heads defined as a first head and a second head, said heads being reversible between a usage position and a stowage position, said pliers comprising:
a pair of handles each of which is pivotable from a first position to a second position, with said handles in said first position said first head is in said usage position and said second head is in said stowage position, with said handles in said second position said first head is in said stowage position and said second head is in said usage position, said handles to be located in juxtaposition in both said usage position and said stowage position; and
each said handle including a convex surface and a concave surface, whereby said convex surfaces and said concave surfaces functions to ergonomically assist in grasping of said handles.

7. The pliers as defined in claim 6 wherein:
each said handle having a pommel, each said pommel to further ergonomically assist in grasping of said handles.

8. The pliers as defined in claim 6 wherein:
each said handle being pivotable about one hundred sixty degrees from said first position to said second position.

9. The pliers as defined in claim 7 wherein:
each said pommel being located directly against a said concave surface.

10. The pliers having a pair of heads defined as a first head and a second head, said heads being reversible between a usage position and a stowage position, said pliers comprising:
a pair of handles each of which is pivotable from a first position to a second position, with said handles in said first position said first head is in said usage position and said second head is in said stowage position, with said handles in said second position said first head is in said stowage position and said second head is in said usage position, said handles to be located in juxtaposition in both said usage position and said stowage position; and
each said handle having a pommel, each said pommel to further ergonomically assist in grasping of said handles.
